(19) United States
(12) Patent Application Publication
(10) Pub. No.: US 2006/0133290 A1
(43) Pub. Date: Jun. 22, 2006

(54) ACK/NACK detection in wireless communication

(76) Inventors: Bengt Lindoff, Bjarred (SE); Johan Nilsson, Hollviken (SE); Peter Malm, Lund (SE)

Correspondence Address: ERICSSON INC., 6300 LEGACY DRIVE, M/S EVR C11, PLANO, TX, 75024, US

(21) Appl. No.: 11/019,333

(22) Filed: Dec. 21, 2004

(51) Int. Cl. H04L 12/26; H04Q 7/24

(52) U.S. Cl. 370/252; 370/338; 370/428; 714/746

(57) ABSTRACT

Improved ACK/NACK detection in a mobile terminal of a wireless communication system is disclosed. The ACK/NACK detection uses knowledge about the power of the acknowledgment/negative acknowledgment signal along with the probability that a DTX will occur to increase the probability that the ACK signal will be correctly detected. The probability that a DTX will occur is determined by observing the transmit power commands issued to the mobile terminal. A high number of power up commands relative to power down commands may indicate a poor quality uplink meaning that a DTX is likely to occur. This Abstract is submitted with the understanding that it will not be used to interpret or limit the scope or meaning of the claims.

### FIELD OF THE INVENTION

The present invention relates generally to modern wireless communication systems and, more particularly, to improving the acknowledgment/negative acknowledgment (ACK/NACK) detection in the transmissions of such wireless communication systems.

### BACKGROUND OF THE INVENTION

In wireless communication systems, the ACK and NACK signals are used to indicate whether a transmitted data packet has been correctly received. If it has, the receiving unit sends an ACK signal to the transmitting unit to transmit a new data block. If it has not, the receiving unit sends a NACK signal to the transmitting unit to retransmit the previous data block. In general, it is more important to correctly detect a NACK signal than an ACK signal because not detecting a NACK signal may result in errors, while not detecting an ACK signal simply results in retransmission. However, the retransmissions may result in delays at the air-interface and only a certain number of retransmissions are typically allowed per block of data over a predefined period of time for a given link.

Detection of the ACK/NACK signals is an important part of an Enhanced Uplink (E-UL) standard currently being studied by the 3rd Generation Partnership Project (3GPP). A goal of the 3GPP, which is a collaboration of wireless communication standards setting bodies, was to produce globally applicable technical specifications for 3rd generation wireless communication systems. One of the requirements of these systems is that the Enhanced Uplink provide significantly reduced air-interface delays, improved availability of high bit rates, and increased capacity, with emphasis on interactive, background (e.g., e-mail, text messaging, etc.), and streaming services.

In the Enhanced Uplink standard, the decision whether to send an ACK or a NACK signal is made by the base station on a per data packet basis. It is then up to the mobile terminal to correctly detect the ACK or a NACK signal. For example, detecting an ACK signal when in actuality a NACK signal was sent will cause packet errors on the higher layers. As a result, an entire set of data packets may need to be retransmitted instead of a single data packet (i.e., where an ACK is mistaken for a NACK), thereby increasing the air-interface delays and reducing the capacity of the uplink. For this reason, it is more important to correctly detect a NACK signal than it is to correctly detect an ACK signal during an Enhanced Uplink session.

Enhanced Uplink may also be used in soft handover situations where the mobile terminal is connected to several base stations. The set of base stations that is connected to the mobile terminal during a soft handover is called the active set. In soft handover, each base station in the active set sends its own ACK/NACK signal to the mobile station independently of other base stations. This means that there is no soft handover gain to be had for the ACK/NACK signal (unlike the case for the downlink data signals). Therefore, the signal-to-interference ratio (SIR) for the ACK/NACK signal is, on average, reduced by a factor of n_{bs}, where n_{bs} is the number of base stations in the active set. In addition, for WCDMA (wideband code division multiple access) systems, power control is implemented on the sum of the downlinks. Consequently, the signal-to-interference ratio for certain downlinks may be very low due to independent fading of those downlinks. This raises a large risk of having an unreliable ACK/NACK signal detection during soft handover.

Furthermore, since the uplink is also power controlled in various CDMA systems (e.g., WCDMA, CDMA-2000, etc.), meaning that only the minimum amount of power necessary will be used, and since it is sufficient that only one of the base stations in the active set be connected to the mobile terminal, there is also a large risk that some of the base stations may momentarily be disconnected from the mobile terminal. When this happens, some of the data packets may not be received at all by those base stations so that no ACK/NACK signal is even sent. In that case, the mobile terminal interprets the lack of an ACK/NACK signal as a discontinuous transmission (DTX). The DTX may also occur in the single link case, but the potential for a discontinuous transmission is greater in the soft handover situation.

### SUMMARY OF THE INVENTION

The present invention is directed to a method and system for improving the ACK/NACK detection in the mobile terminal of a wireless communication system. The method and system of the invention uses knowledge about the power of the ACK/NACK signal along with the probability that a DTX will occur to increase the probability that the ACK signal will be correctly detected. The probability that a DTX will occur is determined by observing the transmit power commands issued to the mobile terminal. A high number of power up commands relative to power down commands may indicate a poor quality uplink, meaning that a DTX is likely to occur.

In general, in one aspect, the invention is directed to a method for improving detection of ACK or NACK signals in a mobile terminal. The method comprises the steps of receiving a radio signal from a base station connected to the mobile terminal that normally includes either an ACK signal or a NACK signal, and estimating a probability of a discontinuous transmission. The method further comprises the steps of calculating a minimum ACK signal threshold for the mobile terminal to correctly detect the ACK signal using the probability of the discontinuous transmission, and detecting whether the ACK signal was received or whether a NACK signal was received using the minimum ACK signal threshold.

In general, in another aspect, the invention is directed to a receiver having improved ACK or NACK signal detection in a mobile terminal of a wireless communication system. The receiver comprises a front end receiver for receiving a radio signal from a base station connected to the mobile terminal, the radio signal normally including either an ACK signal or a NACK signal. The receiver further comprises a control unit for estimating a probability of a discontinuous transmission and a threshold computation unit for calculating a minimum ACK signal threshold for the mobile terminal to correctly detect the ACK signal using the probability of the discontinuous transmission. A detector unit detects whether the ACK signal was received or whether a NACK signal was received using the minimum ACK signal threshold.

In general, in yet another aspect, the invention is directed to a method for improving detection of acknowledgment or negative acknowledgment signals in a mobile terminal at a time when the mobile terminal is connected to multiple base stations. The method comprises the step of receiving a radio signal from multiple base stations at the mobile terminal, each radio signal normally including either an acknowledgment signal or a negative acknowledgment signal. The method further comprises the step of estimating a probability of a discontinuous transmission for each one of the base stations, and calculating a minimum acknowledgment signal threshold for the mobile terminal to correctly detect the acknowledgment signal for each one of the base stations using the probability of a discontinuous transmission for a respective one of the base stations. A detection is then made as to whether the acknowledgment signal was received for each one of the base stations or whether a negative acknowledgment signal was received for each one of the base stations using the minimum acknowledgment signal threshold for a respective one of the base stations.

It should be emphasized that the term comprises/comprising, when used in this specification, is taken to specify the presence of stated features, integers, steps, or components, but does not preclude the presence or addition of one or more other features, integers, steps, components, or groups thereof.

### BRIEF DESCRIPTION OF THE DRAWINGS

The foregoing and other advantages of the invention will become apparent from the following detailed description and upon reference to the drawings, wherein:

FIG. 1 illustrates a portion of a typical wireless communication system in which a mobile terminal may be connected to one base station or to several base stations;

FIGS. 2A-2B illustrate an exemplary ACK, NACK, and DTX implementation;

FIG. 3 illustrates a block diagram of a system for implementing improved ACK/NACK signal detection according to embodiments of the invention; and

FIGS. 4A-4B illustrate flow diagrams of a method for implementing improved ACK/NACK signal detection according to embodiments of the invention.

### DESCRIPTION OF ILLUSTRATIVE EMBODIMENTS OF THE INVENTION

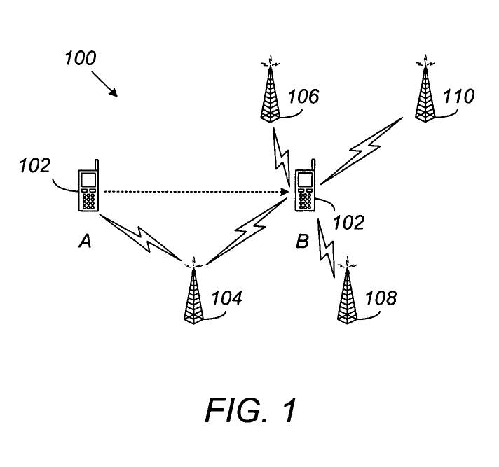

As mentioned above, embodiments of the invention provide a system and method for improved ACK/NACK signal detection in a mobile terminal. FIG. 1 shows a portion of an exemplary wireless communication system 100 according to embodiments of the invention. The wireless communication system 100 includes a mobile terminal and several WCDMA base stations, four of which are shown here at 104, 106, 108, and 110. When the mobile terminal 102 is at location A, it can only receive signals from the first base station 104 and is therefore connected to that base station 104. However, when the mobile terminal moves to location B, it can receive signals from several additional base stations, including base stations 106, 108, and 110. The mobile terminal 102 must then determine which base station 104, 106, 108, and 110 has the strongest signal and switch to that base station. Such a process is commonly called a soft handover and refers to situations where the mobile terminal 102 is connected to the base stations 104, 106, 108, and 110 simultaneously.

For systems such as the wireless communication system 100 and other similar systems, certain requirements have been proposed for the detection of ACK/NACK in the Enhanced Uplink. Since the specific implementation (e.g., amplitude, etc.) of the ACK/NACK signal will be decided independently by each system operator, the signal requirements will be discussed herein in terms of probabilities. One requirement for implementing the Enhanced Uplink is that the probability of the mobile terminal detecting an ACK signal when a NACK signal has been transmitted, P(ACK|NACK), must be less than a certain minimum value, for example, P(ACK|NACK)=1×10⁻⁴. It would be useful, therefore, to provide an ACK/NACK implementation that maximizes the probability of the mobile terminal 102 detecting a true ACK signal, P(ACK|ACK), given P(ACK|NACK)=1×10⁻⁴. In addition, the implementation should be able to account for the probability that the mobile terminal 102 may become disconnected from the base station(s) 104, 106, 108, and/or 110 on the uplink, resulting in neither an ACK nor a NACK signal being transmitted, but rather a DTX. The mobile terminal 102 should then interpret the DTX as a NACK signal; however, the P(ACK|NACK)=1×10⁻⁴ should then be based on the probability of a DTX (i.e., P(ACK|DTX)=1×10⁻⁴). Furthermore, from a system perspective, it is important that the average power level on the ACK/NACK signals be as low as possible due to a finite amount of transmit power available at the base station(s) 104, 106, 108, and/or 110.

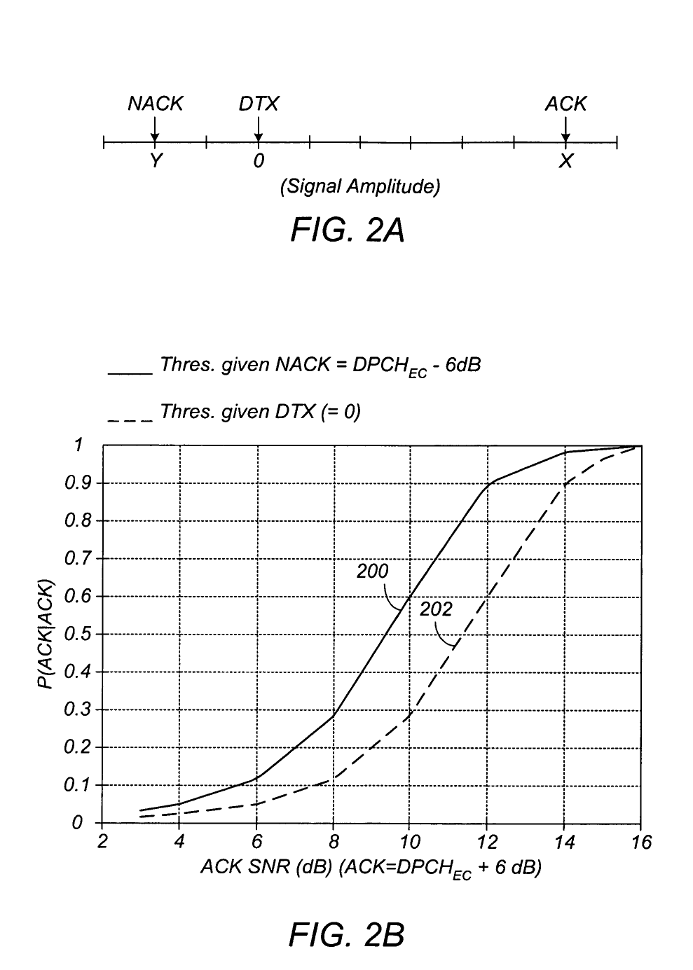

A typical prior art implementation of the ACK, NACK, and DTX is shown in FIG. 2A, where the horizontal line represents a linear scale (e.g., signal amplitude). Ideally, the ACK signal energy should be quite high, whereas the NACK signal energy should be quite low. The DTX is by definition a lack of a signal and should therefore be at zero on the linear scale relative to the ACK and NACK signals, with the NACK signal closer to the DTX than the ACK signal. Thus, in this exemplary implementation, the ACK signal is at X on the linear scale, the DTX is at zero, and the NACK signal is at Y.

One shortcoming of the above implementation is that the ACK and NACK signals are often corrupted by noise. If the noise is sufficiently severe, the mobile terminal 102 may not be able to detect whether a NACK signal was transmitted or whether there was a DTX. To overcome this problem, some implementations set the probability P(ACK|NACK) using the DTX instead of the NACK signal, so that P(ACK|DTX)=1×10⁻⁴ and P(ACK|NACK)<1×10⁻⁴. The tradeoff for such a design choice is that the minimum threshold for the probability P(ACK|ACK) is reduced, potentially causing an increase of the number of unnecessary retransmissions and degrading the capacity and throughput of the uplink.

An example of the above degradation can be seen in FIG. 2B, where the horizontal axis represents the signal-to-noise ratio (SNR) of the ACK signal for an ACK signal having an energy level that is 6 dB higher than the energy level of the dedicated physical channel (DPCH). In other words, E_{C}^{ACK}=E_{C}^{DPCH}+6 dB, where E_{C}^{ACK} is the energy level of the ACK signal per chip and E_{C}^{DPCH} is the energy level of the DPCH signal per chip. The vertical axis represents the probability P(ACK|ACK) of the mobile terminal 102 detecting an ACK signal given that an ACK signal was actually issued. The solid line curve 200 represents the probability of correct ACK signal detection for each link when the DTX is not taken into account (for a NACK signal that is 6 dB lower than the energy level of the DPCH signal). The dashed line 202 represents the probability of correct ACK signal detection for each link when the DTX is taken into account. As can be seen, the signal-to-noise ratio of the ACK signal has to be around 2 dB higher for the second curve 202 for the same P(ACK|ACK). That is, the ACK signal-to-noise ratio has to be higher when the mobile terminal 102 takes into account the DTX compared to when the mobile terminal does not account for DTX. Therefore, it would be desirable to provide a way to distinguish the DTX from the NACK signal whenever possible so that the ACK signal threshold may be set closer to the first curve 200.

In accordance with embodiments of the invention, the NACK signal may be distinguished from the DTX by observing the transmit power control (TPC) commands. The TPC commands are issued by the base station(s) 104, 106, 108, and/or 110 on the downlink to the mobile terminal 102 for setting the terminal output power. Such downlink TPC commands are regularly sent as part of the power control scheme in WCDMA systems, such as the system 100, to control the transmit power of the mobile terminal 102, since it is important in these systems that only the minimum amount of power necessary is transmitted. By determining the number of power “up” commands versus power “down” commands issued, an estimate of whether the uplink between the mobile terminal 102 and the base station(s) 104, 106, 108, and/or 110 is in-synch or out-of-sync. This estimate may then be used by the mobile terminal 102 to ascertain the probability that a DTX will result from the base station(s) 104, 106, 108, and/or 110.

Generally, when an uplink has adequate quality, the ratio of up/down commands is close to unity (i.e., an equal number of “up” versus “down” commands.) On the other hand, if the uplink quality is poor, the number of up commands is usually higher than the number of down commands, as the base station(s) 104, 106, 108, and/or 110 attempts to improve the quality of the link or to reestablish the link. Therefore, the ratio of up versus down commands may be used as a measure of the likelihood that the base station(s) 104, 106, 108, and/or 110 has missed a data packet and will not issue either an ACK or a NACK signal, but will instead be interpreted as a DTX. The higher the number of up commands, the larger the risk that the base station(s) 104, 106, 108, and/or 110 will result in a DTX.

The minimum threshold for the ACK signal may then be adjusted for an individual link (or for each link in the active set if in a soft handover situation) according to the likelihood of a DTX for that link, and also as a function of the ACK and NACK signal power. In one embodiment, the ACK/NACK signal power may be signaled by the base station(s) 104, 106, 108, and/or 110, for example, as an offset to the standard power controlled DPCH signal (i.e., some of the transmitted control bits may be used to indicate the ACK and NACK offset). It is also possible to estimate the ACK/NACK signal power in the mobile terminal 102. In either case, by adjusting the ACK signal threshold according to the probability of a DTX, the probability of P(ACK|ACK) may be increased while still maintaining the required probability P(ACK|NACK). As a result, the number of unnecessary retransmissions may be reduced, thereby increasing the overall capacity and throughput of the link(s).

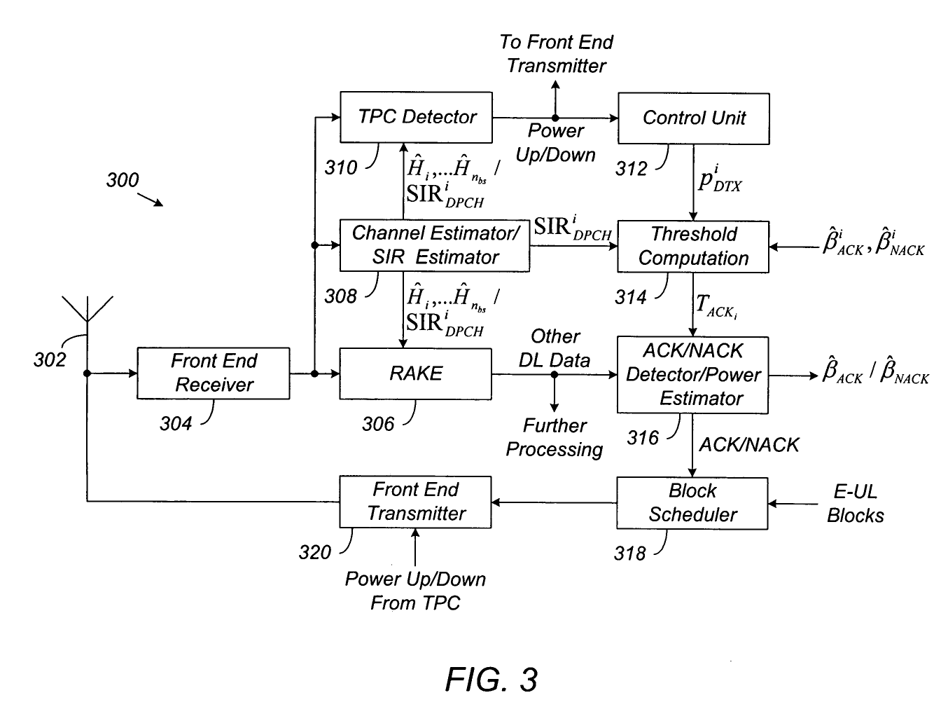

Referring now to FIG. 3, a block diagram of a receiver portion 300 of a mobile terminal is shown that is capable of estimating the probability of a DTX and adjusting the ACK signal threshold accordingly when the mobile terminal is connected to the base station(s) in an Enhanced Uplink session. The receiver portion 300 includes a number of functional components, including an antenna 302 through which a radio signal is received and a front end receiver 304 that subsequently down-converts the radio signal to a baseband. The receiver portion 300 further includes a RAKE receiver 306 for despreading the data in the radio signal and a channel estimator/SIR estimator 308 for estimating the channel response and signal-to-interference ratio of the signal. Also present is a TPC detector 310 for detecting the transmit power commands in the radio signal and a control unit 312 for determining the probability of a DTX based on the ratio of power up versus power down commands. A threshold computation unit 314 calculates the minimum threshold for detecting the ACK signal for each link. An ACK/NACK signal detector/power offset estimator 316 determines whether the ACK/NACK signal detected is reliable. Finally, a block scheduler 318 schedules the data packets to be transmitted, whether a new data packet or a previously transmitted data packet, and a front end transmitter 320 transmits the data packets via the antenna 302. Other functional components not specifically identified herein may also be present in the receiver portion 300 without departing from the scope of the invention.

In operation, a downlink signal that may include the radio signal from a single base station, or multiple base stations if in a soft handover situation, is received through the antenna 302, along with any noise that may be present on the downlink. The radio signal is then down-converted to a baseband signal in the front end receiver 304 and fed to the channel estimator/SIR estimator 308.

The channel estimator/SIR estimator 308 uses the dedicated physical channel (DPCH) pilots to estimate the channel filter taps, Ĥᵢ, . . . Ĥₙ_{_{bs}}, of the DPCH along with the DPCH signal-to-noise ratio, SIRDPCH, for each base station. The channel filter taps may be expressed as Ĥᵢ=[hₖⁱ, . . . h_{L}_{ᵢ}ⁱ] in the soft handover case, where h represents the RAKE finger k for downlink i and L is the number of RAKE fingers for the downlink i. In the single base station, of course, there would be only a single downlink (i.e., i=1). The DPCH signal-to-noise ratio may be stated as SIR_{DPCH}=Ê_{C}^{DPCH}/Î_{DPCH}, where Ê_{C}^{DPCH} represents the energy of the DPCH per chip and Î_{DPCH} represents the interference on the DPCH. This information is then forwarded to the RAKE receiver 306.

The RAKE receiver 306 uses the channel filter taps and the DPCH signal-to-noise ratio information to despread the data in the radio signal, including any ACK/NACK signal in the radio signal. The ACK/NACK signal output from the RAKE receiver 306 is fed to the ACK/NACK signal detector/power offset estimator 316 along with all other data output (e.g., speech/video data, web browsing data, etc.) from the RAKE receiver 306.

The channel filter taps Ĥᵢ, . . . Ĥₙ_{_{bs}} and the DPCH signal-to-noise ratio SIR_{DPCH} from the channel estimator/SIR estimator 308 are also provided to the TPC detector 310 for use in setting the transmit power of the mobile terminal. For each link i, the TPC detector 310 decodes either a power up or a power down command from the received information and provides the power up/down command to the front end transmitter 320 accordingly. The TPC detector 310 also provides the power up/down command to the control unit 312 for estimating a probability P_{DTX}ⁱ that a DTX will occur for the base station(s).

The control unit 312 may estimate the probability P_{DTX}ⁱ that a DTX will occur in a number of ways as a function of the ratio of power up to power down commands over a predetermined number of time slots n. In one embodiment, the control unit 312 considers the ratio Rᵢ of power up to power down commands over the last 50 to 200 time slots (i.e., n=50 to 200). The control unit 312 then defines a baseline value for the probability P_{DTX}ⁱ using the ratio Rᵢ of the base station(s) with which the mobile terminal has the highest quality uplink (i.e., smallest ratio Rᵢ). For example, the baseline probability P_{DTX}ⁱ may be set as P_{DTX}ⁱ=0.1 for the base station with the smallest ratio Rₘᵢₙ, then increased for other base stations with higher ratios Rᵢ. An exemplary probability scheme for a soft handover situation is provided below:

$${p}_{DTX}^{i} = \{ \begin{matrix}0.2 & if & ( {R}_{i} < 3 * {R}_{min} ) \\ 0.5 & if & ( 3 * {R}_{min} < {R}_{i} > 10 * {R}_{min} ) \\ 0.9 & if & ( {R}_{i} > 10 * {R}_{min} )\end{matrix} \} \qquad ( 1 )$$

The probability values chosen in Equation (1) are based on the fact that in uplinks with high quality, power up commands make up less than 60% of the total number of power commands in soft handover, while uplinks with poor quality have close to 100% power up commands. In the case of a single base station, a somewhat different scheme may be applied due to the fact that the potential for a DTX is lower, for example:

$${p}_{DTX}^{i} = \{ \begin{matrix}0.1 & if & {R}_{i < 1.1} \\ 0.3 & if & 1.1 < {R}_{i} > 3 \\ 0.6 & if & {R}_{i} > 3\end{matrix} \} \qquad ( 2 )$$

The probability values shown in Equations (1) and (2) are provided as examples only and other probability values and/or ranges of values may certainly be used without departing from the scope of the invention. For example, optimized values may be provided in some cases based on system simulations or laboratory test results. Other parameters may also be predetermined and used with the probability values and/or ranges of values. These values may be calculated each time by the control unit 312 based on the ratio Rᵢ, or they may be stored in a look-up table in the mobile terminal.

In embodiments where the mobile terminal includes a Doppler estimator (not shown), the values for the ratio Rᵢ as well as the number of time slots n may be a function of the Doppler spread. In that case, input from the Doppler estimator may be used to adapt the values for the ratio Rᵢ and other parameters based on the speed of the mobile terminal. For example, in larger number of time slots (e.g., n=300) should be used for a slow-moving mobile terminal, whereas a smaller number of time slots should be used for a fast-moving mobile terminal (e.g., n=50). Furthermore, in the high-speed case, the values of the ratio Rᵢ should be higher than in the low-speed case due to a larger uncertainty in the power up/down estimation in the high-speed case.

The probability P_{DTX}ⁱ that a DTX will occur is then provided from the control unit 312 to the threshold computation unit 314 for determining the minimum threshold for detecting the ACK signal of each link. In one embodiment, the computation unit 314 uses the probability P_{DTX}ⁱ along with estimates of the power offsets of the ACK and NACK signals and the DPCH signal-to-noise ratio SIR_{DPCH}=Ê_{C}^{DPCH}/Î_{DPCH} to determine the minimum threshold for the ACK signal of each link. For example, the minimum threshold T_{ACK} for the ACK signal for each link may be computed as follows:
T_{ACK}_{ᵢ}=P_{DTX}ⁱ*T_{ACK}^{DTX}+(1−P_{DTX}ⁱ)*T_{ACK}^{NACK} (3)
where
T_{ACK}^{DTX}Φ⁻¹(0.9999,0,I_{ACK/NACK msg}) (4)
and
T_{ANK}^{NACK}Φ⁻¹(0.9999,−\sqrt{β_{NACK}*E_{c}^{DPCH}^{ᵢ}}, I_{ACK/NACK msg}) (5)
and where Φ⁻¹(•) is the inverse of the Gaussian cumulative distribution function (CDF) and “•” represents the content of the parentheses in Equations (4) and (5), β_{NACK}*E_{c}^{DPCH}^{ᵢ}, is the power offset of the NACK signal multiplied by the power level of the DPCH, and I_{ACK/NACK msg} is the interference present on the ACK/NACK signal. The last variable, I_{ACK/NACK msg} may be derived from the interference on the DPCH, Î_{DPCH}, in a manner known to those having ordinary skill in the art. Thus, by using Equation (3), the minimum threshold T_{ACK} for the ACK signal of each link may be adjusted based on the probability P_{DTX}ⁱ that a DTX will occur. As a result, the threshold for the ACK signal of each link may be set closer to the first curve 200 in FIG. 2 where P_{DTX}ⁱ is low.

The minimum threshold T_{ACK} for the ACK signal of each link is thereafter provided to the ACK/NACK detector/power estimator 316 for detecting the ACK signal. In addition, the ACK/NACK detector/power estimator 316 also determines whether the ACK or NACK signal detected was reliable. In one embodiment, the ACK/NACK detector/power estimator 316 determines the reliability of the ACK or NACK signal by examining the DPCH signal-to-noise ratio, SIR_{DPCH}. For example, if the DPCH signal-to-noise ratio is too low, the overall signal quality may be too low for a reliable ACK or NACK signal detection. Therefore, for links that have a DPCH signal-to-noise ratio below a certain threshold, a NACK signal is presumed to be detected.

In some embodiments, the power offsets β_{ACK} and β_{NACK} of the ACK/NACK signal used in the minimum threshold determination may be provided to the ACK/NACK detector/power estimator 316, for example, in the DPCH from the base station(s). In other embodiments, the ACK/NACK detector/power estimator 316 may estimate the power offsets of the ACK/NACK signal. For the latter case, estimated power offsets \hat{β}_{ACK}^{i,j} and \hat{β}_{NACK}^{i,j} of the ACK/NACK signal may be derived as follows:

$$\begin{matrix}{\hat{β}}_{ack}^{ij} = λ \frac{{\hat{E}}_{c}^{ACK} ( i , j )}{{\hat{E}}_{c}^{DPCH} ( i , j )} + ( 1 - λ ) {\hat{β}}_{ACK}^{i , j - 1} , if ACK detected \\ and & ( 6 ) \\ {\hat{β}}_{NACK}^{ij} = λ \frac{{\hat{E}}_{c}^{NACK} ( i , j )}{{\hat{E}}_{c}^{DPCH} ( i , j )} + ( 1 - λ ) {\hat{β}}_{NACK}^{i , j - 1} , if NACK detected and {p}_{DTX}^{j} < 0.3 & ( 7 )\end{matrix}$$

where \hat{β}_{ACK}^{i,j} and \hat{β}_{NACK}^{i,j} are the power offset estimates for the ACK/NACK signal at time instant j for link i, and λ is a filter coefficient (typically 0.95-0.98).

If the power offsets of the ACK/NACK signal are estimated, the ACK/NACK detector/power estimator 316 then updates itself with the newly estimated power offsets \hat{β}_{ACK}^{i,j} and \hat{β}_{NACK}^{i,j}. Generally, the estimated power offset \hat{β}_{ACK}^{i,j} of the detected ACK signal will be updated, but the power offset \hat{β}_{NACK}^{i,j} of the detected NACK signal may not be updated, depending on the probability P_{DTX}ⁱ that a DTX will occur. For example, if the probability P_{DTX}ⁱ is too large, no update of the NACK power offset is made.

Thereafter, the ACK/NACK detector/power estimator 316 forwards the detected ACK/NACK signal to the block scheduler 318 to be used for scheduling the next data packet to be transmitted. If the ACK/NACK detector/power estimator 316 detects an ACK signal as a result of the preceding transmission, the block scheduler 318 schedules a new data packet to be transmitted. On the other hand, if a NACK signal was detected, the block scheduler 318 schedules a retransmission of the previous data packet. Transmission is subsequently performed by the front end transmitter 320 in a manner known to those of ordinary skill in the art.

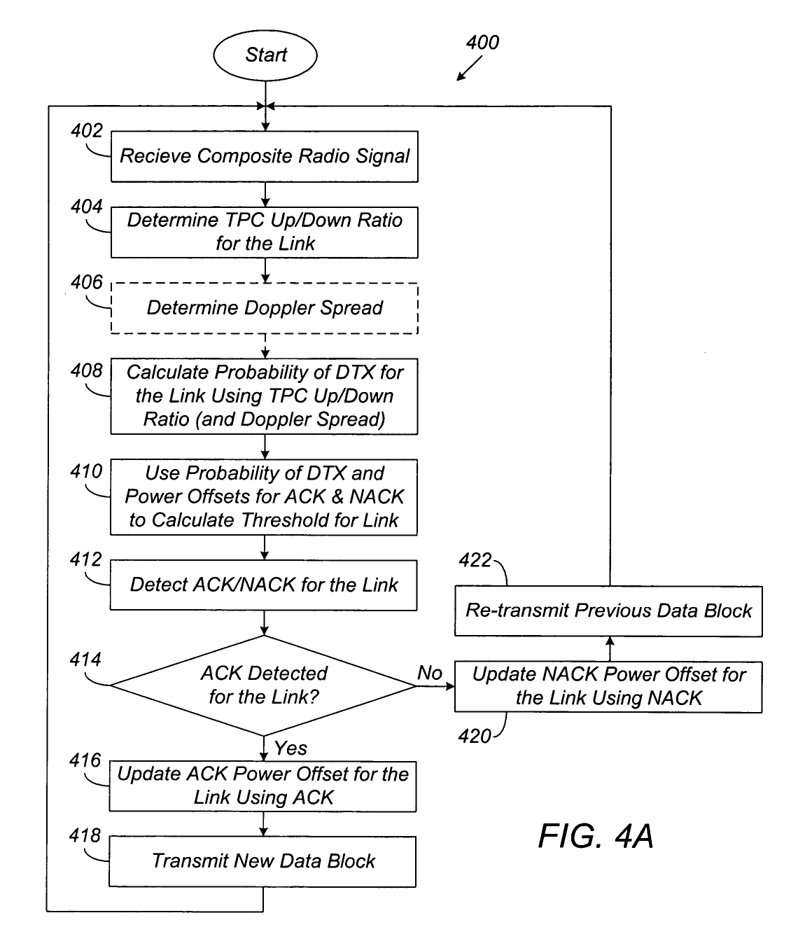

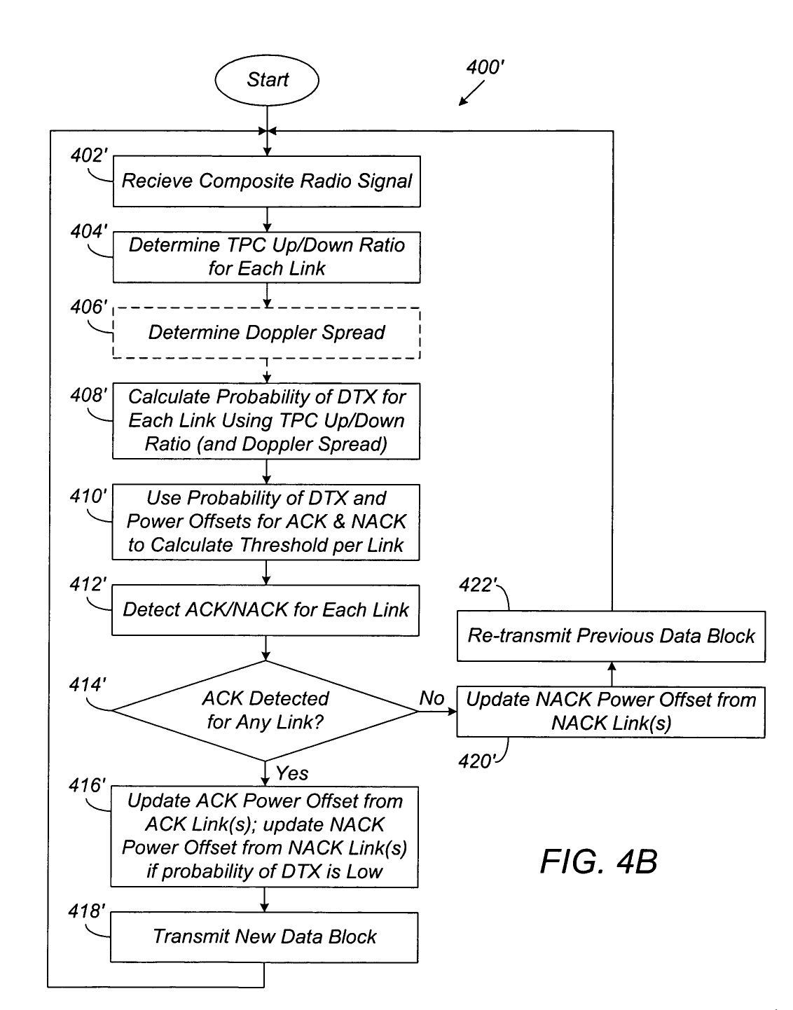

A flow chart 400 for a method that may be used to implement the ACK/NACK signal detection in a mobile terminal according to embodiments of the invention is shown in FIG. 4A. Although the method 400 is described with respect to only a single base station, it may certainly be used when the mobile terminal is connected to multiple base stations in a soft handover situation (as shown in FIG. 4B) without departing from the scope of the invention. The method begins at step 402, where the mobile terminal receives a signal from the base station currently connected to the mobile terminal. The mobile terminal thereafter determines the transmit power up/down ratio for the link of the involved base station in the manner described above, at step 404. If the mobile terminal includes a Doppler estimator (hence, the dashed lines), then the Doppler spread for the mobile terminal is determined at step 406. At step 408, the mobile terminal calculates the probability that a DTX will result for the link using the power up/down ratio. Where available, the Doppler spread may be also be used to adjust the probability of the DTX accordingly.

The mobile terminal thereafter uses the probability of the DTX along with the power offset for the ACK/NACK signal to calculate the minimum threshold for the ACK signal of the involved link at step 410. The power offset may be provided to the mobile terminal from the base station, or the mobile terminal may estimate the power offset in the manner described above. At step 412, mobile terminal detects the ACK/NACK signal for the involved link and determines the reliability of the detection. If the detection for the link is not reliable, a NACK signal is presumed. At step 414, a determination is made as to whether an ACK signal was detected for the link. If the answer is yes, the mobile terminal updates the ACK signal power offset for the link using the ACK signal (step 416) and transmits a new data packet (step 418). If the answer is no, the mobile terminal updates the NACK signal power offset for the link using the NACK signal (step 420) and retransmits the previous data packet (step 422).

FIG. 4B illustrates a flow chart 400′ for a method that may be used in the soft handover case to implement the ACK/NACK signal detection in a mobile terminal according to embodiments of the invention. The method 400′ is otherwise similar to the method 400 of FIG. 4A, except that multiple links are involved. The method begins at step 402′, where the mobile terminal receives a signal from all the base stations involved in the soft handover (i.e., the active set). The mobile terminal thereafter determines the transmit power up/down ratio for the links of each of the involved base stations in the manner described above, at step 404′. If the mobile terminal includes a Doppler estimator (again, the dashed lines), then the Doppler spread for the mobile terminal is determined at step 406′. At step 408′, the mobile terminal calculates the probability P_{DTX}ⁱ that a DTX will result for each link using the power up/down ratio Rᵢ. Where available, the Doppler spread may be also be used to adjust the probability P_{DTX}ⁱ accordingly.

The mobile terminal thereafter uses the probability P_{DTX}ⁱ along with the power offsets for the ACK/NACK signal to calculate the minimum threshold for the ACK signal for each link at step 410′. The power offsets may be provided to the mobile terminal from the base stations, or the mobile terminal may estimate the power offsets in the manner described above. At step 412′, mobile terminal detects the ACK/NACK signal for each link and determines the reliability of the detection. If the detection for a given link is not reliable, a NACK signal is presumed. At step 414′, a determination is made as to whether an ACK signal was detected for any link. If the answer is yes for a link, the mobile terminal updates the ACK signal power offset for the link using the ACK signal at step 416′. The NACK power offset may also be updated at this point using the NACK signal for any link with a low probability of DTX, for example, P_{DTX}ⁱ<0.3. Thereafter, a new data packet is transmitted at step 418′. If the answer is no for a link, the mobile terminal updates the NACK signal power offset for the link using the NACK signal (step 420′) and retransmits the previous data packet (step 422′).

While the present invention has been described with reference to one or more particular embodiments, those skilled in the art will recognize that many changes may be made thereto without departing from the spirit and scope of the present invention. Therefore, each of the foregoing embodiments and obvious variations thereof is contemplated as falling within the spirit and scope of the claimed invention, which is set forth in the following claims.

What is claimed is:

1. A method for improving detection of acknowledgment or negative acknowledgment signals in a mobile terminal, comprising:
receiving a radio signal from a base station connected to said mobile terminal, said radio signal normally including either an acknowledgment signal or a negative acknowledgment signal;
estimating a probability of a discontinuous transmission;
calculating a minimum acknowledgment signal threshold for said mobile terminal to correctly detect said acknowledgment signal using said probability of said discontinuous transmission; and
detecting whether said acknowledgment signal was received or whether a negative acknowledgment signal was received using said minimum acknowledgment signal threshold.

2. The method according to claim 1, further comprising transmitting to said base station a data packet that corresponds to either said acknowledgment signal or said negative acknowledgment signal being received.

3. The method according to claim 2, wherein said data packet that corresponds to said acknowledgment signal is transmitted only if said received acknowledgment signal is determined to be reliable.

4. The method according to claim 1, further comprising determining a reliability of said detected acknowledgment signal or negative acknowledgment signal.

5. The method according to claim 1, wherein said step of estimating said discontinuous transmission probability comprises determining a ratio of transmit power up commands versus transmit power down commands received from said base station.

6. The method according to claim 5, wherein said step of estimating said discontinuous transmission probability further comprises assigning a predetermined probability to said discontinuous transmission probability if said ratio of transmit power up commands versus transmit power down commands is greater than a predefined value.

7. The method according to claim 1, wherein said step of calculating said acknowledgment signal minimum threshold further uses a power offset of said acknowledgment signal and said negative acknowledgment signal.

8. The method according to claim 7, wherein said power offsets are provided to said mobile terminal from said base station.

9. The method according to claim 7, wherein said power offsets are estimated by said mobile terminal.

10. The method according to claim 8, further comprising updating said mobile terminal with said power offset estimates.

11. The method according to claim 4, wherein said step of determining a reliability of said detected acknowledgment signal or said negative acknowledgment signal is performed using a signal-to-noise ratio of a dedicated physical channel of said radio signal.

12. The method according to claim 11, wherein said step of determining a reliability of said detected acknowledgment signal or said negative acknowledgment signal further includes automatically assuming that said radio signal includes a negative acknowledgment signal if said signal-to-noise ratio is below a predetermined level.

13. The method according to claim 1, further comprising adjusting said probability of said discontinuous transmission for Doppler spreading.

14. A receiver having improved acknowledgment or negative acknowledgment signal detection in a mobile terminal of a wireless communication system, comprising:
a front end receiver for receiving a radio signal from a base station connected to said mobile terminal, said radio signal normally including either an acknowledgment signal or a negative acknowledgment signal;
a control unit for estimating a probability of a discontinuous transmission;
a threshold computation unit for calculating a minimum acknowledgment signal threshold for said mobile terminal to correctly detect said acknowledgment signal using said probability of said discontinuous transmission; and
a detector unit for detecting whether said acknowledgment signal was received or whether a negative acknowledgment signal was received using said minimum acknowledgment signal threshold.

15. The receiver according to claim 14, further comprising a signal block scheduler for scheduling transmission of a data packet that corresponds to either said acknowledgment signal or said negative acknowledgment signal being received.

16. The receiver according to claim 15, wherein said signal block scheduler is configured to schedule said transmission of a data packet that corresponds to said acknowledgment signal only if said received acknowledgment signal is determined to be reliable.

17. The receiver according to claim 14, wherein said detector unit also determines a reliability of said detected acknowledgment signal or negative acknowledgment signal.

18. The receiver according to claim 14, wherein said control unit is configured to estimate said discontinuous transmission probability by determining a ratio of transmit power up commands versus transmit power down commands received from said base station.

19. The receiver according to claim 18, wherein said control unit is further configured to assign a predetermined probability to said discontinuous transmission probability if said ratio of transmit power up commands versus transmit power down commands is greater than a predefined value.

20. The receiver according to claim 14, wherein said the threshold computation unit calculates said acknowledgment signal minimum threshold by further using a power offset of said acknowledgment signal and said negative acknowledgment signal.

21. The receiver according to claim 20, wherein said threshold computation unit receives said power offsets from said base station.

22. The receiver according to claim 20, wherein said threshold computation unit is configured to estimate said power offsets.

23. The receiver according to claim 22, wherein said threshold computation unit is further configured to update said mobile terminal with said power offset estimates.

24. The receiver according to claim 17, wherein said detector unit determines said reliability of said detected acknowledgment signal or said negative acknowledgment signal by using a signal-to-noise ratio of a dedicated physical channel of said radio signal.

25. The receiver according to claim 24, wherein said detector unit is configured to automatically assume that said radio signal includes a negative acknowledgment signal if said signal-to-noise ratio is below a predetermined level.

26. The receiver according to claim 14, wherein said control unit is configured to adjust said probability of said discontinuous transmission for Doppler spreading.

27. A method for improving detection of acknowledgment or negative acknowledgment signals in a mobile terminal at a time when said mobile terminal is connected to multiple base stations, comprising:
receiving a radio signal from said multiple base stations at said mobile terminal, each radio signal normally including either an acknowledgment signal or a negative acknowledgment signal;
estimating a probability of a discontinuous transmission for each one of said base stations;
calculating a minimum acknowledgment signal threshold for said mobile terminal to correctly detect said acknowledgment signal for each one of said base stations using said probability of a discontinuous transmission for a respective one of said base stations; and
detecting whether said acknowledgment signal was received for each one of said base stations or whether a negative acknowledgment signal was received for each one of said base stations using said minimum acknowledgment signal threshold for a respective one of said base stations.

28. The method according to claim 27, further comprising transmitting to said base stations a data packet that corresponds to either said acknowledgment signal if an acknowledgment signal is received from any one of said base stations, or said negative acknowledgment signal if no acknowledgment signal is received from any one of said base stations.

29. The method according to claim 28, where said step of transmitting a data packet that corresponds to said acknowledgment signal is performed only if said acknowledgment signal received from any one of said base stations is determined to be reliable.

30. The method according to claim 27, further comprising determining a reliability of each detected acknowledgment signal or negative acknowledgment signal received from said base stations.

31. The method according to claim 27, wherein said step of estimating said discontinuous transmission probability for each one of said base stations comprises determining a ratio of transmit power up commands versus transmit power down commands received from each one of said base stations and assigning a predetermined probability to said discontinuous transmission probability for each one of said base station if said ratio of transmit power up commands versus transmit power down commands is greater than a predefined value for a respective one of said base stations.

32. The method according to claim 27, wherein said step of calculating said acknowledgment signal minimum threshold for each one of said base stations further uses a power offset of said acknowledgment signal and said negative acknowledgment signal, said power offsets provided to said mobile terminal from a respective one of said base stations.

33. The method according to claim 27, wherein said step of calculating said acknowledgment signal minimum threshold for each one of said base stations further uses a power offset of said acknowledgment signal and said negative acknowledgment signal, wherein said power offsets are estimated by said mobile terminal, and wherein said mobile terminal is updated with said power offset estimates.

34. The method according to claim 30, wherein said step of determining a reliability of said detected acknowledgment signal or said negative acknowledgment signal for each one of said base stations is performed using a signal-to-noise ratio of a dedicated physical channel of a radio signal from a respective one of said base stations and further includes automatically assuming that said radio signal from a respective one of said base stations includes a negative acknowledgment signal if said signal-to-noise ratio is below a predetermined level.
